(19) United States
(12) Patent Application Publication
(10) Pub. No.: US 2020/0310482 A1
(43) Pub. Date: Oct. 1, 2020

(54) VOLTAGE REFERENCES AND DESIGN THEREOF

(71) Applicant: UNIVERSITY OF UTAH RESEARCH FOUNDATION, Salt Lake City, UT (US)

(72) Inventors: Ali Azam, Salt Lake City, UT (US); Jeffrey Walling, Salt Lake City, UT (US)

(21) Appl. No.: 16/825,071

(22) Filed: Mar. 20, 2020

Related U.S. Application Data
(60) Provisional application No. 62/825,127, filed on Mar. 28, 2019.

(51) Int. Cl. G05F 3/24

(52) U.S. Cl. CPC G05F 3/245

(57) ABSTRACT

Embodiments of the disclosure are drawn to voltage reference circuits and methods of designing same. The voltage reference circuit may include a main stage and one or more auxiliary stages. The output of the main stage may be a reference voltage. The auxiliary stages may provide a feedback voltage that reduces a temperature dependence of the reference voltage. Each stage may include two or more transistors. The transistors may operate in a sub-threshold mode to provide the reference voltage.

### RELATED APPLICATION(S)

This application claims priority to U.S. Provisional Application No. 62/825,127 filed on Mar. 28, 2019, the contents of which are incorporated herein by reference for any purpose.

### BACKGROUND

Voltage references are key building blocks for most analog and digital circuits and systems. They are used extensively in voltage regulators, analog-to-digital converters and bias circuitry. Cutting edge complementary metal oxide semiconductor (CMOS) technology has paved the way for a new era of low power applications and opportunities (e.g., internet-of-things (IoT), sensor networks and interfaces, energy harvesting, wireless charging, brain-machine interface, low power actuators, etc.).

Most modern CMOS processes use a supply voltage of ˜1V or lower owing to device geometries. Consequently, conventional bandgap references require separate supply voltage domains due to reduced voltage headroom. In contrast, threshold voltage has not scaled much with feature size reduction. Hence, there is a growing demand for ultra-low power voltage references capable of providing an output comparable to the threshold voltage that can be powered with sub-1V supply voltages.

Traditional approaches to designing voltage references involve bipolar junction transistors (BJT), where two linearly temperature variant voltages and/or currents are generated. The positive and the negative temperature dependent slopes cancel out when combined to generate a temperature independent voltage reference. However, most BJT based approaches are power hungry (>1 μW) and they also require higher supply voltages as the devices operate in forward active region. Another popular approach is to use feedback amplifiers and large resistors for error correction, which limits the minimum supply voltage and minimum power consumption, as each device requires voltage headroom to be in saturation.

Recent trends in designing voltage references use metal oxide semiconductor (MOS) devices in the sub-threshold region. This facilitates device operation with very low voltage headroom. Moreover, it helps to reduce power consumption by 4 to 5 orders of magnitude. Recent works have reported sub-nanowatt power consumption with excellent temperature coefficients (TC) and line sensitivities (LS) with the ability to operate below 1V. Two-transistor (2T) based voltage references offer excellent performance but the output reference voltage (175.3 mV) is often too low compared to the threshold voltage of the devices in modern CMOS. A cascaded 4T reference boosts the output voltage (343 mV) but it does not offer a good temperature-coefficient (33 ppm/° C.). In addition, the minimum supply voltage that can be used is 0.5 V because the devices require a 3˜4V_{T} voltage headroom in order to minimize non-linear temperature dependency.

There is a growing demand for ultra-low power voltage references with good TC and LS that generates output voltages that can be fed to external circuitry without level shifting. It is also desirable to push the supply voltage as low as possible so that it can be powered by wireless power transfer or energy scavenging (e.g., RF, TEG, solar, etc.).

### SUMMARY

Typically, power amplifiers are used to increase the output voltage (V_{REF}) of voltage references. In one or more embodiments, instead of using a power amplifier, a voltage reference circuit (e.g., a main stage) is coupled to a bulk feedback circuit to increase the output voltage and to reduce the temperature coefficient (e.g., reduce the temperature dependence of V_{REF}).

In one or more embodiments, the bulk-feedback circuit includes two auxiliary stages (M3-M4 and M5-M6). The bulk-feedback circuit may boost the output voltage of V_{REF} without using typical cascode topology. Including two stages may improve temperature performance.

The temperature gradient in the voltage reference circuit from low voltage operation may be compensated with replica paths. Depending on the complementary-to-absolute-temperature (CTAT) or proportional-to-absolute temperature circuit (PTAT) nature of temperature gradient of the main stage, the feedback circuit can be designed to control the bulk voltage of the main stage using a replica stage that may be optimized to provide an opposing operation. If the main stage has a PTAT (CTAT) response, the feedback (e.g., auxiliary) stages may be designed to provide PTAT (CTAT) responses. This is because increasing (decreasing) the bulk voltage increases (decreases) the threshold voltage, which may compensate for temperature dependent reduction in the output reference voltage. In short, the concept is to use a temperature dependent voltage source (CTAT/PTAT) to control the threshold voltage to compensate for the temperature dependency of the reference.

In some embodiments, transistors may be metal-oxide-semiconductor field-effect transistors (MOSFETs). In some embodiments, M2 and M4 may be deep N-well MOSFETs. In some embodiments, transistors may be 65 nm CMOS transistors. In some embodiments, the voltage reference circuit, including both the voltage reference and feedback portions, may operate in the sub-threshold range of one or all of the transistors.

Transistors in the main stage may be selected to have the same width-to-length (W/L) ratio. The length may be increased to reduce power consumption or decreased to reduce layout area. The width may be optimized to reduce temperature sensitivity.

After the main stage has been designed, the characteristic equation for the feedback circuit may be found by sweeping the voltage (Vbulk) across the main stage, where Vbulk=VOS−cT. VOS is the offset voltage, T=temperature, and c=performance coefficient.

The W/L ratios of transistors of a first auxiliary stage of the feedback circuit may be selected to generate a value of c that provides a temperature dependency that counteracts the temperature dependency of the voltage reference circuit. That is, as discussed above, the feedback circuit is designed to act as either a CTAT or a PTAT, depending on the behavior of the voltage reference circuit so that the temperature dependencies cancel out. Once the W/L ratios are determined to find the desired c, the size of each transistor may be scaled by the same factor to optimize VOS. For example, in some embodiments, VOS may be optimized such that VREF is close to the drain supply voltage (VDD). The second auxiliary stage may be selected in a similar manner to the first auxiliary stage.

### BRIEF DESCRIPTION OF THE DRAWINGS

FIG. 1 is a circuit diagram of a voltage reference circuit in accordance with examples described herein.

FIG. 2 is a plot of width of devices versus temperature coefficients in accordance with examples described herein.

FIG. 3 is a circuit diagram illustrating sweeping of bulk voltage in accordance with examples described herein.

FIG. 4 shows plots of a reference voltage versus temperature and feedback voltage versus temperature in accordance with examples described herein.

FIG. 5 shows a chip layout of a voltage reference circuit in accordance with examples described herein.

FIG. 6 is a plot of an output reference voltage as a function of supply and temperature in accordance with examples described herein.

FIG. 7 is a plot of the reference voltage of an example reference voltage circuit versus the supply voltage in accordance with examples described herein.

FIG. 8 is a plot of current versus temperature in accordance with examples described herein.

FIG. 9 is a plot of power supply rejection ratio versus frequency in accordance with examples described herein.

### DETAILED DESCRIPTION

The following description of certain embodiments is merely exemplary in nature and is in no way intended to limit the scope of the disclosure or its applications or uses. In the following detailed description of embodiments of the present apparatuses, systems and methods, reference is made to the accompanying drawings which form a part hereof, and which are shown by way of illustration specific embodiments in which the described apparatuses, systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

According to examples of the present disclosure, an ultra-low-power voltage reference which works on the principle of cancellation of temperature dependency on sub-threshold current is disclosed. The feedback control which is based on bulk-voltage compensation, may not only suppresses the second order temperature dependency but may also enable it to achieve a much higher output voltage using supply voltages as low as 0.35 V. The closed-loop control may provide reliable performance over all process corners in sub-threshold operation. A disclosed example design achieves a line sensitivity of 0.004%/V at 200 C and power supply rejection ratio (PSRR) of −45 dB with total power consumption of 12.9 pW. The temperature coefficient is 8.3 ppm/0 C over a temperature range of −10-1100 C and a supply range of 0.35-2.5V. Disclosed herein is a complete feedback-controlled pico-watt voltage reference which may have a stable temperature coefficient and line sensitivity while having an output voltage (293.5 mV) comparable to the supply voltage even if it is operated with a supply voltage as low as 350 mV.

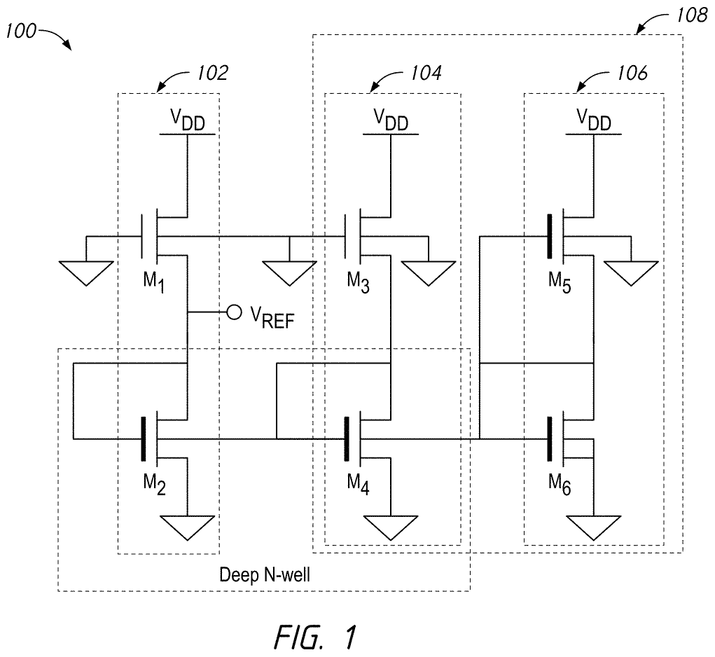

FIG. 1 is a circuit diagram of a voltage reference circuit 100 in accordance with examples described herein. The voltage reference circuit 100 is based on sub-threshold operation, but instead of using an open loop configuration or a feedback amplifier, the voltage reference circuit 100 uses a complementary-to-absolute-temperature (CTAT) voltage source to control the bulk voltage of the reference voltage generator. The voltage reference circuit 100 may not only boost the output voltage without using a cascode topology, but the bulk feedback may also reduce the temperature coefficient (TC). The voltage reference circuit 100 may include a main stage 102 for generating a reference voltage and a bulk feedback network (e.g., feedback network) 108, which may reduce temperature variations in the reference voltage.

The main (e.g., first) stage 102 may include a first MOSFET device M₁ and a second MOSFET device M₂ coupled in series. The gate of M₁ may be coupled to a common voltage (e.g., ground). The drain of M₁ may be coupled to a voltage source V_{DD} (e.g., supply voltage). The source of M₁ may be coupled to the drain and the gate of M₂. The source of M₂ may be coupled to the common voltage. A reference voltage V_{REF} may be provided at a node between the source of M₁ and the gate and drain of M₂. In some examples, M₁ may be a native 2.5V device with a low threshold voltage (Vₜₕ). In some examples, M₂ may be a 2.5V I/O device with a higher Vₜₕ than M₁. In some examples, the devices M₁ and M₂ may be N-channel MOSFETS.

The current through each device, I_{D}, may be dictated by the sub-threshold current equation of MOSFET devices as shown below

$${I}_{D} = {k}^{′} ( f - 1 ) {V}_{T}^{2} {e}^{\frac{( {V}_{G S} - {V}_{t h} ( {V}_{B S} ) )}{f {V}_{T}}} ( {e}^{\frac{- {V}_{S B}}{VT}} - {e}^{\frac{- {V}_{D B}}{V T}} + \frac{{V}_{D S}}{{V}_{A}} ) . \qquad ( 1 )$$

Where k′ is the mobility of the device, f is the work function, V_{T} is the thermal voltage, V_{GS} is the gate-to-source voltage, Vₜₕ is the threshold voltage, V_{BS} is the substrate (e.g., bulk)-to-source voltage, V_{SB} is the source-to-substrate voltage, V_{DB} is the drain-to-substrate voltage, V_{D}S is the drain-to-source voltage, and VA is the early voltage. Equation (1) can be simplified in some examples by assuming that the bulk and source are at the same potential:

$${I}_{D} = {k}^{′} ( f - 1 ) {V}_{T}^{2} {e}^{\frac{( {V}_{G S} - {V}_{t h} )}{{fV}_{T}}} ( 1 - e \frac{- {V}_{D S}}{{V}_{T}} + \frac{{V}_{D S}}{{V}_{A}} ) . \qquad ( 2 )$$

In some examples, it can be assumed that V_{D}S is large enough so that

$${e}^{\frac{- {V}_{D S}}{{V}_{T}}}$$

can be neglected. In some examples, both devices (M₁ and M₂) may carry equal current, in these examples, the reference voltage V_{REF} can be simplified by equating both current equations as follows:

$${V}_{REF} = ( {f}_{1} \vert \vert {f}_{2} ) Δ {V}_{th} + ( {f}_{1} \vert \vert {f}_{2} ) {V}_{T} ln ( \frac{{k}_{1}^{′}}{{k}_{2}^{′}} ) . \qquad ( 3 )$$

Where f₁ is the work function for M₁, f₂ is the work function for M₂, k′₁ is the mobility of M₁, k′₂ is the mobility of M₂, and ΔVₜₕ is the threshold voltage difference between M₁ and M₂. Equation (2) shows that properly sized devices having k₁=k₂ can lead to a fixed reference voltage:

V_{REF}∝(Vₜₕ₁−Vₜₕ₂)−C₀₁+C₁T−C₀₂+C₂T=ΔC₀+TΔC. (4)

Where Vₜₕ₁ is the threshold voltage of M₁, Vₜₕ₂ is the threshold voltage of M₂, T is temperature, C₀₁ and C₀₂ are the combined temperature independent factors whereas C₁ and C₂ are the summation of all temperature dependent factors up to the first order in the threshold voltage. Both devices may have identical TCs (C₁ and C₂), which may provide a constant reference voltage output.

Equation (3) describes the performance of voltage reference if the desired performance is not too stringent (e.g., TC<20 ppm/° C.). However, some approximations and simplifications may cause deviation from the theoretical calculations in some applications.

In some examples, it may be assumed that V_{DS}>>V_{T}. Hence, the exponential term within the parenthesis in Equation (2) is reduced, but the linear term may cause a deviation. Moreover, increasing V_{DS} may mean increasing the minimum supply voltage of the circuit in some applications. In some examples, the device M₁ may suffer from the body effect while the device M₂ may not if both the devices have their bulk (e.g., substrate) connected to ground. In some examples, it may be assumed that both the devices M₁ and M₂ may have significant Vₜₕ difference, but may have equal temperature coefficients. All these factors may contribute to either CTAT or PTAT like nature with small non-linear temperature dependency especially if the desired reference voltage is comparable to the supply voltage.

Feedback circuits using amplifiers are power hungry and require large voltage headroom to retain the devices in the saturation region. Moreover, they require another stable reference voltage.

An energy efficient feedback mechanism is to control the body voltage of the main stage 102 with one or more auxiliary PTAT or CTAT stages in the bulk feedback network 108. Returning to FIG. 1, a first auxiliary stage 104, which may include MOSFET devices M₃ and M₄ coupled in series. The drain of M₃ may be coupled to the voltage source V_{DD} and the gate of M₃ may be coupled to the substrate of M₁ and the common voltage. The substrate of M₃ may be coupled to the common voltage. The source of M₃ may be coupled to the drain and gate of M₄ as well as the substrate of M₂. The source of M₄ may be coupled to the common voltage. In some examples, M₃ and M₄ may be N-channel devices. In some examples, M₃ may be a native device and M₄ may be a deep N-well device.

Optionally, a second auxiliary stage 106 including devices M₅ and M₆ coupled in series may be included to compensate for the temperature dependency of the main stage (M₁-M₂). In some applications, adding a second auxiliary stage 106 may further reduce temperature sensitive of the reference voltage. However, in some examples, the second auxiliary stage 106 may be omitted, which may save power and/or die area. Second auxiliary stage 106 may include MOSFET devices M₅ and M₆. The gates of M₅ and M₆ may be coupled to the substrate of M₄. The source of M₅ and the drain of M₆ may also be coupled to the substrate of M₄. The drain of M₅ may be coupled to the voltage source V_{DD} and the substrate of M₅ may be coupled to the common voltage. The substrate and source of M₆ may be coupled to the common voltage. In some examples, M₅ and M₆ may be N-channel devices. In some examples, M₅ and M₆ may be standard I/O devices.

In some examples, deep N-well devices may be used for M₂ and M₄ which are available in most modern CMOS processes. M₃ and M₄ the second stage 104 (e.g., first auxiliary stage) may create a negative feedback for the main stage 102. M₅ and M₆ of the third stage 106 (e.g., second auxiliary stage) may be included to reduce temperature sensitivity of the first auxiliary stage 104. As a result, a TC as low as 8.3 ppm/° C. can be achieved for an output voltage of 293.5 mV. In some examples, the maximum supply may be determined by the device break-down rating which may be 2.5V for the I/O devices in the used process.

To design a voltage reference circuit according to the present disclosure, such as voltage reference circuit 100, the main stage 102 (M₁-M₂) may be sized with low V_{DS} so that it can be operated with very low V_{DD}. Designing the main stage 102 with low V_{DS} may increase its temperature dependence. This may be compensated for by the bulk feedback network (e.g., the two auxiliary stages 104, 106).

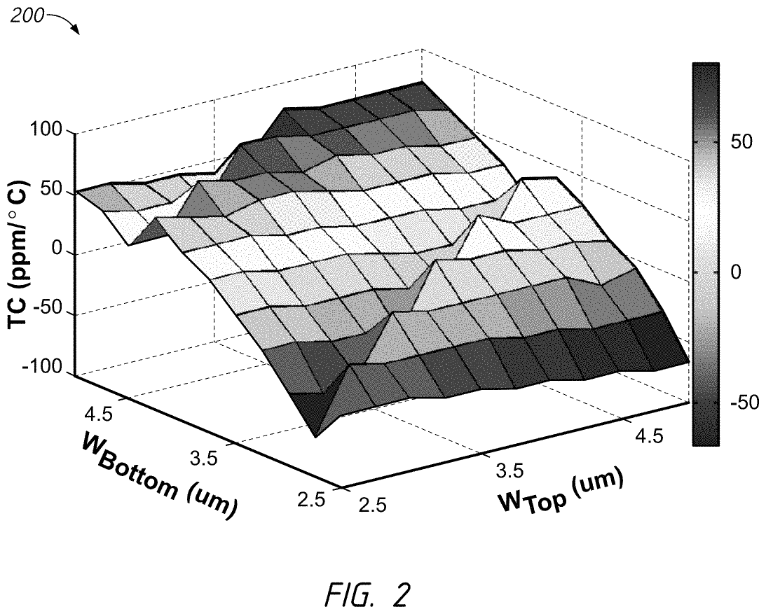

In some examples, M₁ and M₂ may have the same W/L ratio which may achieve low temperature dependency. In an example implementation, the length of both the devices were chosen as 80 μm which may reduce power consumption. In other examples, shorter lengths may be chosen to reduce size, but may come at the expense of increased power consumption. The widths of the devices M₁ and M₂ may be optimized using a plot of TV versus widths of the devices M₁ and M₂. In the example plot 200 shown in FIG. 2, TCs over a temperature range of −20 to 130° C. are plotted for different widths of M₁ (W_{Top}) and M₂ (W_{Bottom}). In some embodiments, equal widths W are chosen for M₁ and M₂. For example, equal widths where the TC is the lowest may be selected. Though any equal width can be chosen for both devices M₁ and M₂, smaller widths may cause larger mismatches between the devices in some applications.

Once the main stage 102 is designed, the feedback network 108 including auxiliary stages 104 and 106 may be optimized to reduce the TC of the main stage 102 by controlling the bulk proportional to the output voltage. The main stage 102 in the example implementation has a slightly negative TC (−20 ppm/° C.); hence the feedback network may be designed so that it has an overall negative TC.

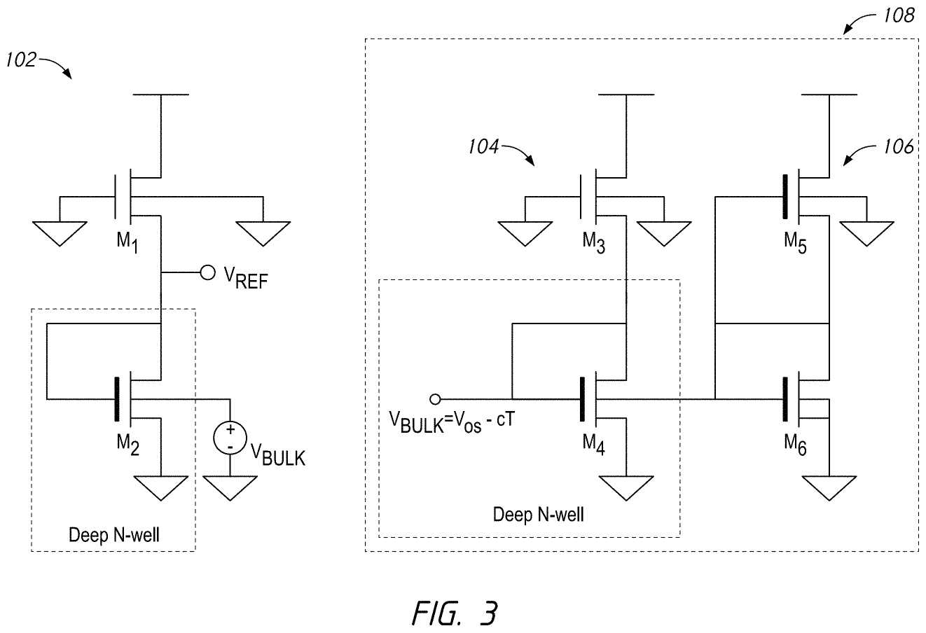

As illustrated in FIG. 3, in some examples, the desired characteristic equation of the feedback network 108 (e.g., auxiliary stages 104, 106) may be found by sweeping the bulk voltage (e.g., substrate voltage) of device M₂. The bulk voltage (V_{BULK}) is equal to Vₒₛ−cT where Vₒₛ is the offset voltage, T is temperature, and c is a constant, which corresponds to the desired temperature coefficient (TC) of the feedback network 108.

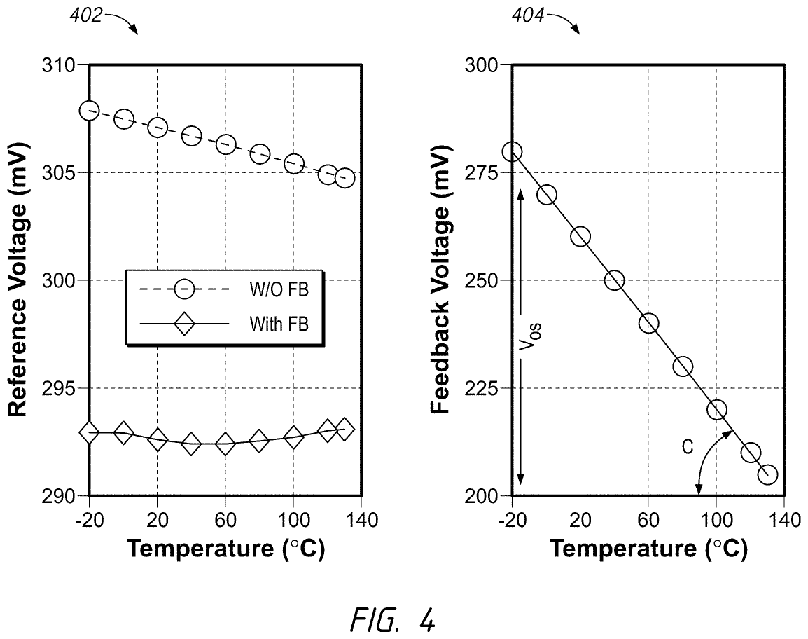

FIG. 4 shows reference voltage versus temperature plot 402 and feedback voltage versus temperature plot 404 in accordance with examples described herein. Plot 402 is a plot of the reference voltage provided by the main stage 102 with and without feedback (FB) (e.g., from feedback network 108) versus temperature. Plot 404 is a plot of the feedback voltage (e.g., the voltage provided by auxiliary stages 104, 106) versus temperature. The desired TC of the feedback network 108 may be determined from plot 404 of FIG. 4 by finding the slope of the voltage versus temperature line. The widths of the devices M₃ and M₄ can then be selected in a similar procedure to M₁ and M₂ of the main stage 102 using a plot similar to the plot shown in FIG. 2, where TC corresponds to the value of the constant c as shown in FIG. 4. Thus widths of M3 and M4 may be selected to provide the desired TC of the first auxiliary stage 104. In some examples, the value of the constant c may determine the performance of the reference voltage over temperature while the value of the offset voltage Vₒₛ may determine the output voltage level. Once the length and width of the devices are determined, the value of Vₒₛ may be optimized by scaling both the devices M₃ and M₄ by the same factor. A scaling factor of two is used in the example implementation to set the reference voltage close to V_{DD}. The second auxiliary stage 106 (M₅-M₆) may be included to improve the performance over temperature. The second auxiliary stage 106 may work as local feedback to the first auxiliary stage 104. The devices M₅ and M₆ of the second auxiliary stage 106 may be designed using the same procedure as was used for the first auxiliary stage 104. In the example implementation, the geometry for each device is: M₁: 3.6u/80u, M₂: 3.65u/80u, M₃: 500n/80u, M₄: 100u/80u, M₅: 400n/40u and M₆: 400n/40u.

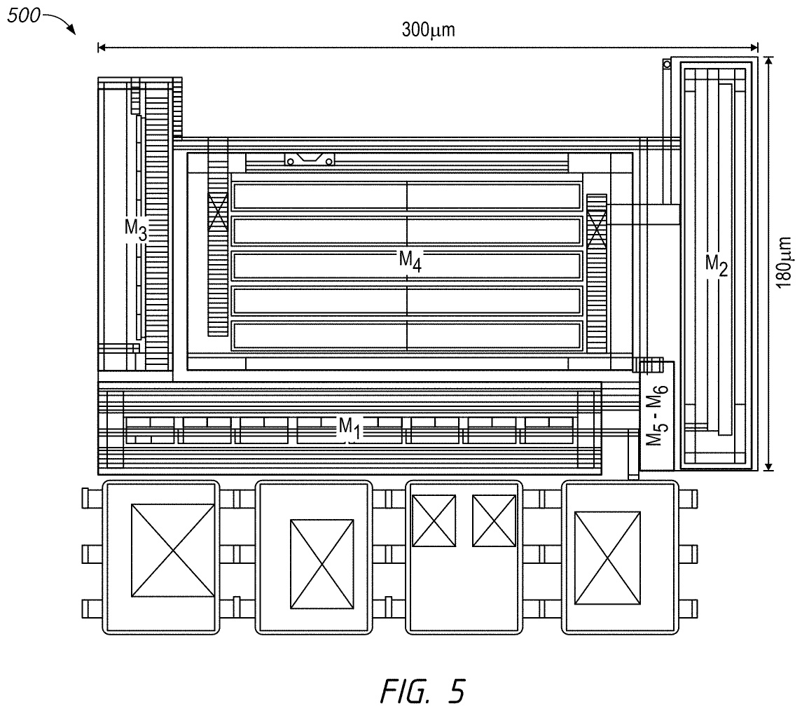

The voltage reference circuit 100 may be implemented in a 65 nm CMOS process. The gate lengths of the devices may be chosen to be large to reduce power consumption. However, the same output voltage performance can be achieved with smaller length devices at the expense of higher power consumption. Hence, there may be a trade-off between area and power consumption. FIG. 5 shows a chip layout 500 of a voltage reference circuit. In some examples, the chip layout 500 may be used to implement the voltage reference circuit 100 shown in FIG. 1.

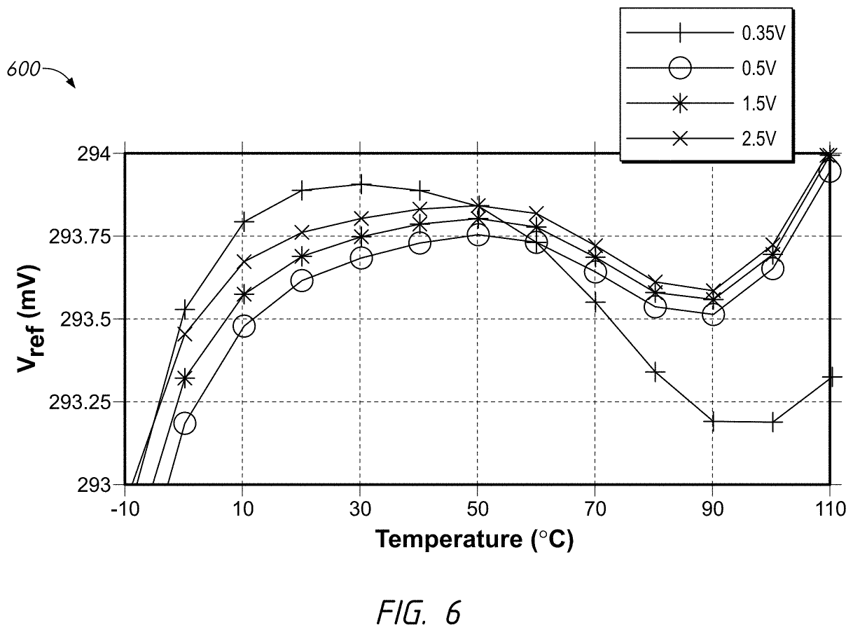

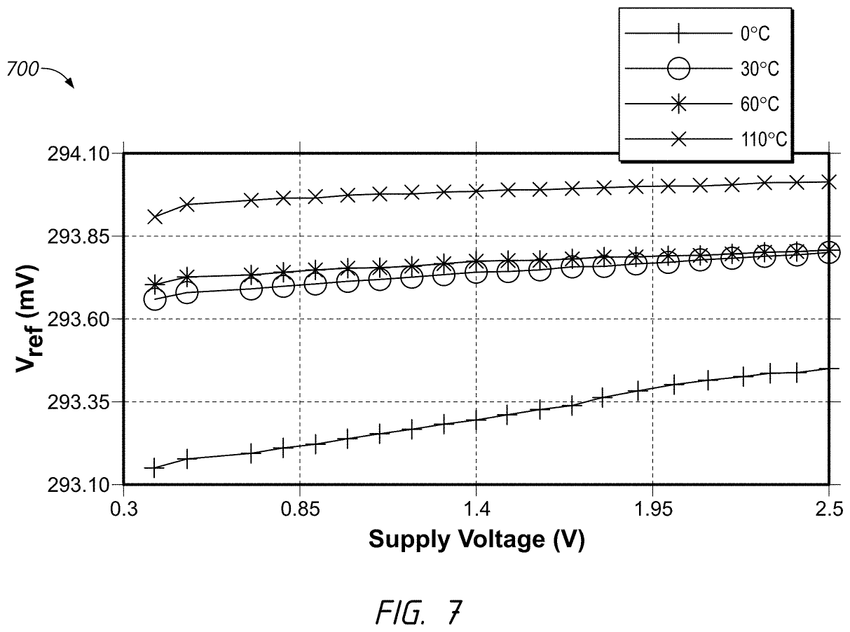

The example implementation of voltage reference circuit 100 having chip layout 500 was simulated over supply voltages from 0.35-2.5V and over temperature from −20° C.-130° C. FIG. 6 shows a plot 600 the output reference voltage as a function of supply and temperature of the simulated voltage reference circuit. The voltage reference circuit described herein varies by approximately only 1 mV over a temperature range of −10 to 110 degrees Celsius. The voltage reference circuit described herein may to reduce the overall TC. FIG. 7 shows a plot 700 of the reference voltage of the example reference voltage circuit versus the supply voltage, which is a measure of the line sensitivity of the reference voltage circuit. As seen in plot 700, the worst line sensitivity (0.012%/V) occurs at 0° C. while the best line sensitivity (0.004%/V) occurs at 60° C.

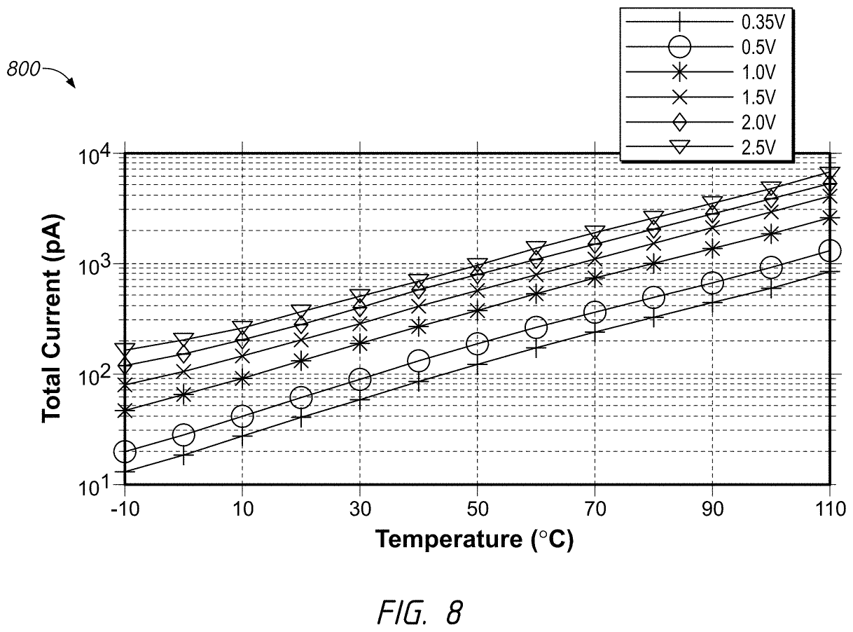

The example implementation of the voltage reference circuit was designed in 65 nm CMOS; hence it may have a much higher leakage current compared to wider line CMOS devices or more advanced technology nodes using high-K gate dielectrics or FinFETs. Thick gate-oxide, high-voltage (2.5 V) devices may be used to increase the supply voltage range. FIG. 8 is a plot 800 of current versus temperature in accordance with examples described herein. Plot 800 shows the total system current including I/O pads. The current increases exponentially with temperature. The minimum power consumption is approximately 4.8 pW at −10° C.

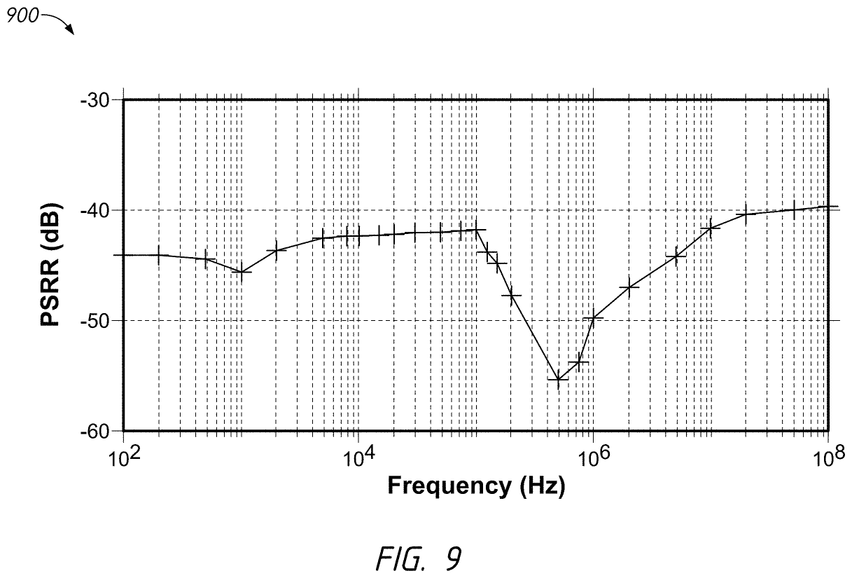

FIG. 9 is a plot 900 of power supply rejection ratio versus frequency in accordance with examples described herein. As shown in plot 900, the example implementation of the voltage reference circuit has <−43 dB power supply rejection ratio even without external output capacitors up to 10 MHz, with a resonance around 1 MHz due to modelled bondwire inductance.

An ultra-low power voltage reference circuit has been disclosed herein which in some examples may exhibit an output voltage of 293 mV even after being supplied by voltage as low as 350 mV. Instead of using conventional amplifiers, in some examples, properly sized CTAT or PTAT stage may be used as feedback to the main stage. This may facilitates operations at lower V_{DD} with ultra-low power consumption. The voltage reference circuit described herein may achieve a temperature coefficient of 7.3 ppm/° C. with line sensitivity of 0.004%/V with a total power consumption of 13.6 pW without any trimming in some examples.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a main stage comprising a first transistor and a second transistor coupled in series between a voltage source and a common voltage, wherein a reference voltage is provided at a node between a source of the first transistor and a drain of the second transistor; and
a bulk feedback network coupled to a substrate of the second transistor.

2. The apparatus of claim 1, wherein the main stage and the bulk feedback network include complementary-to-absolute-temperature circuits.

3. The apparatus of claim 1, wherein the main stage and the bulk feedback network include proportional-to-absolute temperature circuits.

4. The apparatus of claim 1, wherein the bulk feedback network includes a first stage comprising a third transistor and a fourth transistor coupled in series between the voltage source and the common voltage, wherein a gate of the third transistor is coupled to the common voltage and a gate of the fourth transistor is coupled to the substrate of the second transistor.

5. The apparatus of claim 4, wherein the bulk feedback network further includes a second stage comprising a fifth transistor and a sixth transistor coupled in series between the voltage source and the common voltage, wherein a gate of the fifth transistor and a gate of the sixth transistor are coupled to a substrate of the fourth transistor.

6. The apparatus of claim 5, wherein a source of the fifth transistor is coupled to the substrate of the fourth transistor and a substrate of the sixth transistor is coupled to the common voltage.

7. The apparatus of claim 5, wherein the fifth transistor and the sixth transistor include I/O devices.

8. The apparatus of claim 4, wherein the second transistor and the fourth transistor include deep N-well devices.

9. The apparatus of claim 4, wherein the first transistor and the third transistor include native devices.

10. The apparatus of claim 4, wherein a source of the third transistor is coupled to the substrate of the second transistor.

11. The apparatus of claim 1, wherein a width of the first transistor and a width of the second transistor have a same value.

12. The apparatus of claim 1, wherein a threshold voltage of the first transistor has a value less than a value of a threshold voltage of the second transistor.

13. The apparatus of claim 1, wherein the source of the first transistor is further coupled to a gate of the second transistor.

14. A method, comprising:
plotting a temperature coefficient as a function of width of a first transistor;
plotting the temperature coefficient as a function of width of a second transistor; and
based on the plotting, selecting a first width of the first transistor and a second width of the second transistor associated with a lowest value of the temperature coefficient where the first width and the second width have equal values.

15. The method of claim 14, further comprising:
sweeping a bulk voltage of the second transistor across a range of voltages;
calculating a desired temperature coefficient based, at least in part, on the bulk voltage of the second transistor across the range of voltages; and
selecting a third width of a third transistor and a fourth width of a fourth transistor associated with the desired temperature coefficient.

16. The method of claim 15, further comprising:
sweeping a bulk voltage of the fourth transistor across the range of voltages;
calculating a second desired temperature coefficient based, at least in part, on the bulk voltage of the fourth transistor across the range of voltages; and
selecting a fifth width of a fifth transistor and a sixth width of a sixth transistor associated with the second desired temperature coefficient.

17. The method of claim 15, further comprising providing a reference voltage from a node between a source of the first transistor and a drain of the second transistor, wherein the first transistor and the second transistor are coupled in series, the third and the fourth transistor are coupled in series, and wherein a gate of the fourth transistor is coupled to a substrate of the second transistor.

18. The method of claim 15, wherein the third width is different than the fourth width.

19. The method of claim 15, wherein lengths of the first transistor, the second transistor, the third transistor, and the fourth transistor have equal values.

20. The method of claim 15, further comprising scaling the third width and the fourth width by a same factor.
